(19) United States
(12) Patent Application Publication
(10) Pub. No.: US 2025/0355594 A1
(43) Pub. Date: Nov. 20, 2025

(54) Methods and Systems for Processing-in-Memory Scope Release

(71) Applicant: Advanced Micro Devices, Inc., Santa Clara, CA (US)

(72) Inventors: Sooraj Puthoor, Austin, TX (US); Nuwan S. Jayasena, Cupertino, CA (US); Matthew David Sinclair, Middleton, WI (US)

(73) Assignee: Advanced Micro Devices, Inc., Santa Clara, CA (US)

(21) Appl. No.: 18/665,240

(22) Filed: May 15, 2024

(51) Int. Cl. G06F 3/06

(52) U.S. Cl. CPC G06F 3/0659; G06F 3/0611; G06F 3/0679

(57) ABSTRACT

Processing-in-memory scope release operation is described. An example system may include a memory, a processing-in-memory processor associated with the memory, and a memory controller. The memory controller is configured to receive a memory request for the processing-in-memory processor. The memory request is associated with a region of the memory. The memory controller is also configured to schedule writing, into the memory, cached data associated with the region of the memory; and delay scheduling the memory request of the processing-in-memory processor until the cached data is transmitted from the memory controller to the memory.

### BACKGROUND

Processing-in-memory (PIM) architectures move processing of memory-intensive computations to memory. This contrasts with standard computer architectures which communicate data back and forth between a memory and a processing unit. In terms of data communication pathways, processing units of conventional computer architectures are further away from memory than processing-in-memory processors. As a result, these conventional computer architectures suffer from increased data transfer latency, which can decrease overall computer performance. Further, due to the proximity to memory, PIM architectures can also provision higher memory bandwidth and reduced memory access energy relative to conventional computer architectures particularly when the volume of data transferred between the memory and the processing unit is large. Thus, processing-in-memory architectures enable increased computer performance while reducing data transfer latency as compared to conventional computer architectures that implement processing hardware outside of, or far from, memory.

### BRIEF DESCRIPTION OF THE DRAWINGS

FIG. 1 is a block diagram of an example system having a host with at least one core and multiple memory modules, where each of the multiple memory modules includes a memory associated with a processing-in-memory processor and a memory controller.

FIG. 2 is a block diagram if an example system that includes multiple compute units connected to at least one memory device via an interconnect/interface.

FIG. 3 is a block diagram of an example system that includes a memory controller configured to implement a processing-in-memory scope release operation.

FIG. 4 depicts a procedure in an example implementation of processing-in-memory scope release operations.

### DETAILED DESCRIPTION

### Overview

Computer architectures with PIM processors implement processing devices embedded in memory hardware (e.g., memory chips). By implementing PIM processors in memory hardware, PIM architectures are configured to provide memory-level processing capabilities to a variety of applications, such as applications executing on a host processing device that is communicatively coupled to the memory hardware. In such implementations where the PIM processor provides memory-level processing for an application executed by the host processing device, a host processing device controls the PIM processor by dispatching one or more application operations for performance by the PIM processor. In some implementations, a host tasks a PIM processor and one or more host processing devices to process data stored in a shared region of memory. In conventional computer architectures that do not implement PIM processors, a host processing device executing operations that would otherwise be offloaded to a PIM processor can trigger a system scope release operation to flush cached data to a cache or buffer that is visible to other host processing devices that execute operations involving the same region of memory.

In scenarios where a memory is shared by one or more different processing devices, cached memory writes released via a system scope operation may still not be visible to a PIM processor attempting to access the same corresponding region of the memory. Conventional architectures may thus result in consistency issues if a PIM processor accesses data stored at a memory address that has not yet been updated with memory write transactions that are cached at an upstream location even if the cached data has been released to a system scope level that is visible to other host processing devices but not to the PIM processor.

To address these conventional problems, methods and systems for processing-in-memory scope release is described. In implementations, a system includes a memory, a memory controller, and a PIM processor associated with the memory. The memory is communicatively coupled via the memory controller to at least one core of at least one host, such as a core of a host processor. In implementations, the memory controller is implemented locally at a host processor, implemented at the memory, or is implemented separate from a host processor and the memory. In implementations, copies of data stored in a region of the memory are cached in one or more caches of the system.

To enable executing transactions that involve processing the data stored in the region of the memory, the memory controller is configured to receive memory requests from one or more host processing devices (e.g., cores), including memory requests for the PIM processor. For example, a host may submit regular memory requests which do not necessarily require processing by the PIM processor as well as PIM memory requests indicative of memory addresses that the PIM processor is to access, for example, as part of executing a transaction at the PIM processor. The memory controller is also configured to schedule writing, into the memory, cached data associated with the region of the memory. For example, the cached data includes copies of the data that are cached in a local cache of a first host processing device, a local cache of a second host processing device, a shared cache visible to both the first and second host processing devices, and/or a coherence directory (e.g., probe filter) visible to all the host processing devices. However, the cached data may include memory writes that are not visible to the PIM processor until they are written to the memory.

In implementations, the memory controller is also configured to delay scheduling a memory request received for the PIM processor (e.g., from a host) until cached data associated with the same region of the memory that is to be accessed by the PIM processor, are transmitted to the memory first. For example, the memory controller is configured to perform a flush operation to transfer data from one or more caches to the memory, including the cached data associated with certain memory addresses identified in the memory request of the PIM processor. In implementations, the cached data related to the memory request of the PIM processor can be identified based on the memory addresses identified in the memory request. For example, the cached data may be stored or buffered in one or more caches upstream of the memory controller and/or in the coherence directory, and thus may not yet be visible to the PIM processor even if it is visible to the host processing devices. Thus, in examples, the cached data is first propagated into a command queue of the memory controller to be scheduled for transmission to the memory prior to scheduling the memory request of the PIM processor. In an example, the command queue is configured to implement a comparator that delays scheduling the memory request of the PIM processor until one or more queued memory writes issued from one or more host processing devices to be written into the same memory addresses of the memory request of the PIM processor are first processed (e.g., transmitted to the memory).

In this manner, the memory controller ensures that all memory writes from the host processing devices that are not yet visible to the PIM processor are flushed to the memory before a PIM transaction that depends on these memory writes is executed. Advantageously, the present system thus ensures data consistency for the PIM transaction even in an event where one or more threads executing in the host processing devices are concurrently processing cached versions of the data associated with the memory request of the PIM processor.

In contrast to conventional computing architectures, the techniques described herein enable conflict-free scheduling of PIM transactions without implementing locks on data maintained at one or more memory addresses, thereby avoiding computational costs incurred by setting and releasing memory locks (e.g., computation, interconnect/memory bandwidth required to set and check memory locks). As a further advantage relative to conventional systems, the techniques described herein enable scheduling PIM transactions to PIM processors that are managed by different memory controllers without necessarily requiring a host to flush all memory writes (including those that are not dependencies of the specific memory request of a certain PIM processor) into the memory. Thus, the described techniques do not create additional traffic on an interface between a memory module implementing the PIM processor and the memory controllers or a host processor requesting performance of the transaction.

In some aspects, the techniques described herein relate to a system including: a memory; a processing-in-memory processor associated with the memory; a memory controller, the memory controller configured to: receive a memory request for the processing-in-memory processor, wherein the memory request is associated with a region of the memory; schedule writing, into the memory, cached data associated with the region of the memory; and delay scheduling the memory request of the processing-in-memory processor until the cached data is transmitted from the memory controller to the memory.

In some aspects, the techniques described herein relate to a system, wherein the cached data corresponds to memory write requests from a host configured to access the memory via the memory controller.

In some aspects, the techniques described herein relate to a system, wherein the memory controller is further configured to identify the region of the memory based on one or more memory requests including the memory request of the processing-in-memory processor.

In some aspects, the techniques described herein relate to a system, further including: a host; and a command queue configured to buffer memory requests from the host, wherein the memory controller is configured to adjust an order of the memory requests such that one or more memory requests associated with the region of the memory are scheduled prior to the memory request of the processing-in-memory processor.

In some aspects, the techniques described herein relate to a system, wherein the memory controller is further configured to update a ready bit of the memory request of the processing-in-memory processor in the command queue after the one or more memory requests associated with the region of the memory are transmitted from the memory controller to the memory, wherein updating the ready bit enables scheduling the memory request of the processing-in-memory processor.

In some aspects, the techniques described herein relate to a system, further including a coherence directory configured to buffer the cached data, wherein the memory controller is further configured to obtain the cached data from the coherence directory in response to receiving the memory request for the processing-in-memory processor.

In some aspects, the techniques described herein relate to a method including: receiving a memory request for a processing-in-memory processor, wherein the memory request is associated with a region of a memory; writing, to the memory, cached data associated with the region of the memory; and delay scheduling the memory request of the processing-in-memory processor until the cached data is written to the memory.

In some aspects, the techniques described herein relate to a method, wherein the cached data corresponds to pending memory write operations requested by one or more processors configured to access the memory via a memory controller.

In some aspects, the techniques described herein relate to a method, further including flushing the cached data from one or more caches in response to receiving the memory request for the processing-in-memory processor.

In some aspects, the techniques described herein relate to a method, further including identifying the region of the memory based on one or more memory requests including the memory request of the Processing-in-memory processor.

In some aspects, the techniques described herein relate to a method, further including: buffering, in a command queue of a memory controller, memory requests from one or more processors.

In some aspects, the techniques described herein relate to a method, further including: adjusting an order of the memory requests in the command queue such that one or more memory requests associated with the region of the memory are scheduled prior to the memory request of the processing-in-memory processor.

In some aspects, the techniques described herein relate to a method, further including updating a ready bit of the memory request of the processing-in-memory processor in the command queue in response to transmission of the one or more memory requests associated with the region of the memory from the memory controller to the memory, wherein updating the ready bit enables scheduling the memory request of the processing-in-memory processor.

In some aspects, the techniques described herein relate to a method, further including obtaining the cached data from a coherence directory associated with one or more processors in response to receiving the memory request for the processing-in-memory processor.

In some aspects, the techniques described herein relate to a method, further including receiving one or more markers to release write requests to the memory; and responsive to processing the one or more markers, writing, to the memory, the cached data associated with the region of the memory.

In some aspects, the techniques described herein relate to a method, wherein the one or more markers to release write requests to the memory are processed to release the write requests from at least one of a coherence directory configured to buffer the cached data or an interface between the coherence directory and a memory controller.

In some aspects, the techniques described herein relate to a method, further including buffering the memory request for the processing-in-memory processor in a separate queue from a processing-in-memory command queue until any write requests dependent on the memory request for the processing-in-memory processor are processed, wherein the write requests dependent on the memory request are identified using hardware comparator logic of a memory controller configured to perform a processing-in-memory address comparison with addresses of the write requests.

In some aspects, the techniques described herein relate to a device including: a processing-in-memory processor associated with a memory; a memory controller, the memory controller configured to: receive a memory request for the processing-in-memory processor, wherein the memory request is associated with a region of the memory; schedule writing, into the memory, cached data associated with the region of the memory; and delay scheduling the memory request of the processing-in-memory processor until the cached data is transmitted from the memory controller to the memory.

In some aspects, the techniques described herein relate to a device, further including: a command queue configured to buffer memory requests from one or more processing devices.

In some aspects, the techniques described herein relate to a device, wherein the memory controller is configured to: adjust an order of the memory requests such that one or more memory requests associated with the region of the memory are scheduled prior to the memory request of the processing-in-memory processor; and update a ready bit of the memory request of the processing-in-memory processor in the command queue after the one or more memory requests associated with the region of the memory are transmitted from the memory controller to the memory, wherein updating the ready bit enables scheduling the memory request of the processing-in-memory processor.

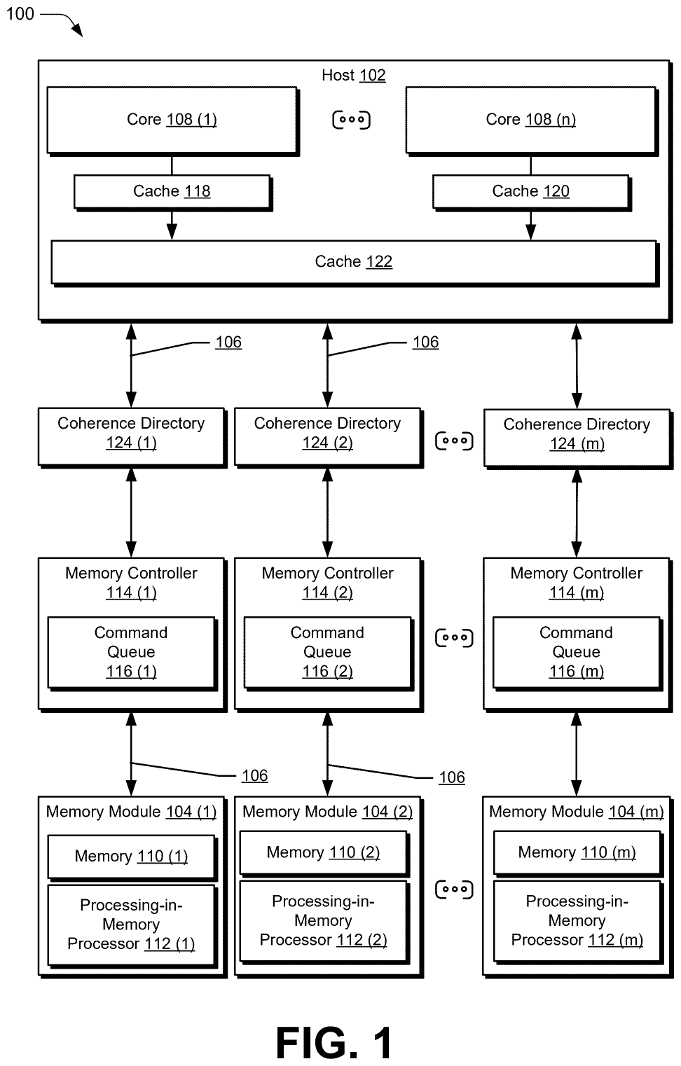

FIG. 1 is a block diagram of an example system 100 having a host with at least one core and multiple memory modules, where each of the multiple memory modules includes a memory associated with a processing-in-memory processor and a memory controller.

In particular, the system 100 includes host 102 and multiple memory modules 104. For instance, in the illustrated example of FIG. 1, system 100 includes memory module 104(1), memory module 104(2) and memory module 104 (m), where m represents any integer. The host 102 is connected to individual ones of the memory modules 104 via a communicative coupling, such as the connection/interface 106. In one or more implementations, the host 102 includes at least one core 108. In some implementations, the host 102 includes multiple cores 108. For instance, in the illustrated example of FIG. 1, host 102 is depicted as including core 108(1) and core 108(n), where n represents any integer. Each of the memory modules 104 includes a memory 110 and a processing-in-memory processor 112.

In accordance with the described techniques, the host 102 is connected to each of the multiple memory modules 104 via a wired or wireless connection, such as the connection/interface 106. Example wired connections include, but are not limited to, buses (e.g., a data bus), interconnects, traces, and planes. Examples of devices in which the system 100 is implemented include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

The host 102 is an electronic circuit that performs various operations on and/or using data in the memory 110 (e.g., at least two of the memories 110(1) to 110(m)). Examples of the host 102 and/or a core 108 of the host include, but are not limited to, a central processing unit (CPU), a graphics processing unit (GPU), a field programmable gate array (FPGA), an accelerated processing unit (APU), and a digital signal processor (DSP). For example, in one or more implementations a core 108 is a processing unit that reads and executes instructions (e.g., of a program), examples of which include to add data, to move data, and to branch data.

In one or more implementations, each memory module of the multiple memory modules 104 is a circuit board (e.g., a printed circuit board), on which a corresponding portion of the memory 110 is mounted and includes a corresponding one of the multiple processing-in-memory processors 112. Although described and illustrated in the context of different memory segments being implemented as separate memory modules, the techniques described herein are applicable to different system architectures where different segments of memory are alternatively or additionally configured in different manner such as memory interleaving architectures, memory channel segmentation architectures, memory module segmentation architectures, memory region segmentation architectures, combinations thereof, and so forth.

In some variations, one or more integrated circuits of a memory are mounted on the circuit board of the memory module 104 (e.g., memory 110(1) of memory module 104(1)), and each of the multiple memory modules 104 includes one or more processing-in-memory processors 112. Examples of the multiple memory modules 104 include, but are not limited to, TransFlash memory modules, single in-line memory modules (SIMM), dual in-line memory modules (DIMM), and combinations thereof. In one or more implementations, each of the multiple memory modules 104 is a single integrated circuit device that incorporates a respective portion of the memory 110 and a respective one of the multiple processing-in-memory processors 112 on a single chip. In some examples, one or more of the multiple memory modules 104 is composed of multiple chips that implement a respective portion of the memory 110 and a respective one of the multiple processing-in-memory processors 112 that are vertically (“3D”) stacked together, are placed side-by-side on an interposer or substrate, or are assembled via a combination of vertical stacking or side-by-side placement.

Each portion of the memory 110 (e.g., the memory 110(1), memory 110(2), and memory 110(m)) is a device or system that is used to store information, such as for immediate use in a device (e.g., by a core 108 of the host 102 and/or by a corresponding one of the multiple processing-in-memory processors 112). In one or more implementations, each portion of the memory 110 corresponds to semiconductor memory where data is stored within memory cells on one or more integrated circuits. In at least one example, the memory 110 corresponds to or includes volatile memory, examples of which include random-access memory (RAM), dynamic random-access memory (DRAM), synchronous dynamic random-access memory (SDRAM), static random-access memory (SRAM), combinations thereof, and so forth.

For example, one or more portions of the memory 110 represents high bandwidth memory (HBM) in a 3D-stacked implementation. Alternatively or additionally, one or more portions of the memory 110 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). The memory 110 is thus configurable in a variety of ways that support memory verification (e.g., of the memory 110) using processing-in-memory without departing from the spirit or scope of the described techniques.

Broadly, each of the multiple processing-in-memory processors 112 is configured to process processing-in-memory operations involved as part of one or more transactions (e.g., operations of a transaction received from a core 108 via the connection/interface 106). Each processing-in-memory processor 112 is representative of a processor with example processing capabilities ranging from relatively simple (e.g., an adding machine) to relatively complex (e.g., a CPU/GPU compute core). Thus, each processing-in-memory processor 112 is or includes one or more processors. In an example, each processing-in-memory processor 112 processes the one or more transactions by executing associated operations using data stored in a corresponding portion of the memory 110 that is accessible by the processing-in-memory processor. For instance, processing-in-memory processor 112(1) executes operations using data stored in memory 110(1), processing-in-memory processor 112(2) executes operations using data stored in memory 110(2), and processing-in-memory processor 112(m) executes operations using data stored in memory 110(m).

Processing-in-memory contrasts with standard computer architectures which obtain data from memory, communicate the data to a processing unit (e.g., a core 108 of the host 102), and process the data using the processing unit (e.g., using a core 108 of the host 102 rather than one or more of the multiple processing-in-memory processors 112). In various scenarios, the data produced by the processing unit as a result of processing the obtained data is written back to memory, which involves communicating the produced data over the connection/interface 106 from the processing unit to memory. In terms of data communication pathways, the processing unit (e.g., a core 108 of the host 102) is further away from the memory 110 than the processing-in-memory processor 112, both physically and topologically. As a result, conventional computer architectures suffer from increased data transfer latency, reduced data communication bandwidth, and increased data communication energy, particularly when the volume of data transferred between the memory and the processing unit is large, which can also decrease overall computer performance.

Thus, each of the multiple processing-in-memory processors 112 enables increased computer performance while reducing data transfer energy as compared to standard computer architectures that implement processing hardware outside, or further from, the memory. Further, the multiple processing-in-memory processors 112 alleviates memory performance and energy bottlenecks by moving one or more memory-intensive computations closer to the memory 110. Although the processing-in-memory processors 112 are each illustrated as being disposed within a corresponding one of the multiple memory modules 104, in some examples, the described benefits of memory verification using processing-in-memory are realizable through near-memory processing implementations in which one or more of the multiple processing-in-memory processors 112 are disposed in closer proximity to the memory 110 (e.g., in terms of data communication pathways) than a core 108 of the host 102.

The system 100 is further depicted as including multiple memory controllers 114. In implementations, the system 100 includes one memory controller 114 for each memory segment (e.g., one memory controller 114 for each multiple memory modules 104). Individual ones of the multiple memory controllers 114 are configured to receive a request to perform at least one operation involved in executing a transaction that the host 102 requests to be executed by the multiple processing-in-memory processors 112. Although depicted in the example system 100 as being implemented separately from the host 102, in some implementations one or more of the multiple memory controllers are implemented locally as part of the host 102. Each memory controller 114 is further representative of functionality to schedule PIM transactions for a plurality of hosts, despite being depicted in the illustrated example of FIG. 1 as serving only a single host 102. For instance, in an example implementation a memory controller 114 schedules PIM transactions for a plurality of different hosts, where each of the plurality of different hosts include one or more cores that request execution of at least one operation (e.g., by a processing-in-memory processor 112) to complete a PIM transaction.

Each of the multiple memory controllers 114 is further depicted as including a command queue 116. The command queue 116 is configured to buffer memory requests from any of the host processing devices (e.g., a core 108), including memory requests for any of the PIM processors (e.g., PIM processor 112). In an example, the command queue 116(1) enqueues memory requests (e.g., memory writes, memory reads, etc.) issued from any of core 108(1), core 108(n) and/or PIM processor 112(1).

In the illustrated example, the host 102 also includes one or more caches 118, 120, 122. The caches 118, 120, 122 are configured to store cached data corresponding to stored data in memory addresses of the memory 110(1), 110(2), and/or 110(m). In an example, cache 118 is a local cache of core 108(1) that is configured to temporarily store data (e.g., as cache lines) transmitted from the core 108(1) to be written into a region of memory 110(1), 110(2), and/or 110(m). Additionally or alternatively, the cached data may include data that is read from the memory 110 (e.g., the cache 118 may be a read-write cache). It is noted that various aspects of the present invention are applicable to read-write caches as well as write caches. In an example, memory writes stored in cache 118 are visible to core 108(1) but not to core 108(n) (e.g., level 1 cache). In an example, cache 122 (e.g., level 2 cache) stores cached data that is visible to both core 108(1) and core 108(n).

In the illustrated example, system 100 also includes a coherence directory 124 for each of the memory modules 104. The coherence directory 124 includes any device configured to keep track of cached data corresponding to memory addresses of an associated memory 110. For example, the coherence directory 124(1) includes a probe filter or directory configured to identify regions of memory 110(1) for which at least one cache line is cached in any of caches 118, 120, 122 and a state of the cached data (e.g., dirty memory, etc.) corresponding to each region of the memory 110(1). In some examples, a coherence directory 124 buffers cached data that is visible to memory requests (e.g., memory read requests) submitted from any of the host processing devices of host 102 (e.g., core 108).

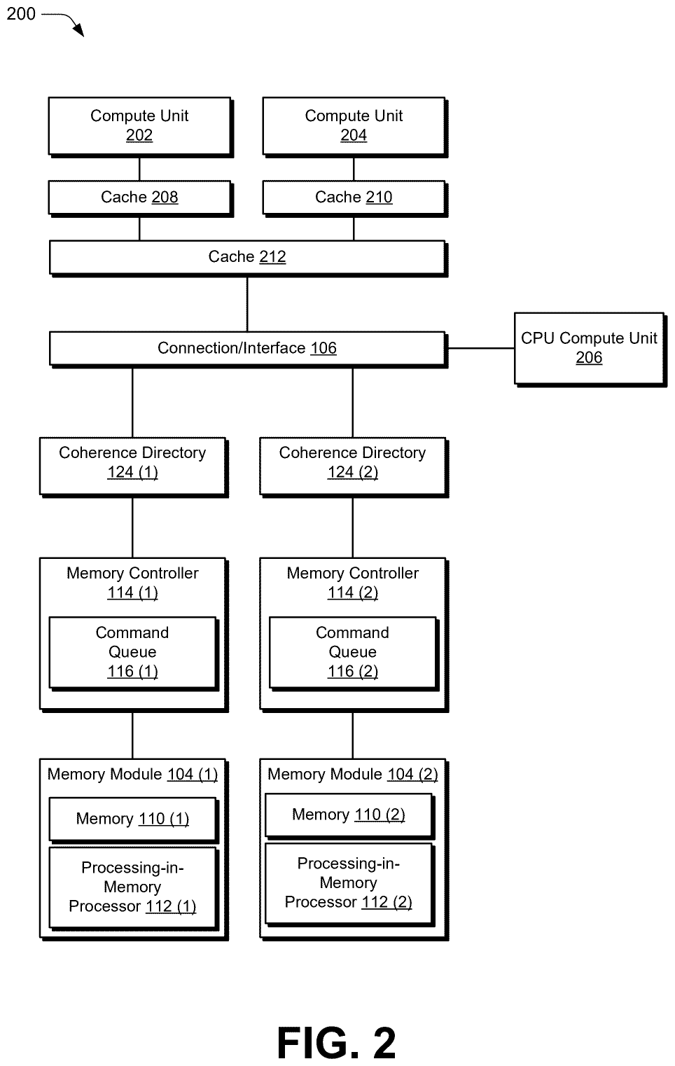

FIG. 2 is a block diagram if an example system 200 that includes multiple compute units connected to at least one memory device via an interconnect/interface. The system 200 is depicted as including a plurality of compute units 202, 204, 206. Example compute units of the compute units 202, 204, 206 include a single host 102, multiple different hosts, a single core 108 of the host 102, different cores of the host 102, or combinations thereof. In an example, the compute units 202, 204 are configured as a workgroup (e.g., compute units of a GPU) assigned to execute a task (e.g., parallel threads) and the compute unit 206 is configured as a CPU compute unit. The example system 200 in also shown to include caches 208, 210, 212.

For example, each of the compute units 202, 204 may be connected to a level 1 cache (e.g., caches 208, 210) in which cached data is directly visible (e.g., for a memory read operation) to one but not both of the compute units 202, 204. Thus, in this example, the caches 208, 210 can be referred to as a workgroup scope of the system 200. Further, in this example, cached data in a level 2 cache (e.g., cache 212) is visible to both of the compute units 202 and 204 but not compute unit 206. Thus, in this example, cache 212 may be referred to as a device scope in the system 200. Further, in this example, data stored (or flushed) in a coherence directory 124 is visible to any compute unit in the system 200, and thus transferring or flushing cached data to coherence directory(s) 124 may be referred to as a system scope release operation.

In examples, the system 200 is configured to perform a PIM scope release operation to propagate or flush cached data from any of the caches 208, 210, 212 and/or the coherence directories 124 into the memory 110 so as to be visible to the PIM processor 112. In an example, flush markers (or release markers) executed by any of the threads operating in compute units 202, 204, and/or 206 are used to release memory writes to the PIM scope and/or the system scope. For example, a flush marker is inserted by any of the compute units 202, 204, 206 to trigger flushing data from a coherence directory 124 to a corresponding memory controller 114 (e.g., into command queue 134), and another flush marker is inserted to flush data from the memory controller 114 to the memory 110 (i.e., where it would be visible to the PIM processor 112). In an alternative or additional example, a single flush or release marker is inserted to trigger flushing cached data from the system scope (e.g., coherence directory 124) to the PIM scope (e.g., memory 110).

In an alternative or additional example, a system scope release operation is modified to extend beyond the coherence directory(s) 124. For example, the system scope release operation is extended to an interface between the coherence directory(s) 124 and the memory controller(s) 114. In this way, in variations where the system scope release is implemented with a flush marker, the flush marker returns when pending writes (e.g., all of them) are issued to the interface between the coherence directory(s) 124 and the memory controller(s) 114. In an alternative or additional example, a hardware-assisted dependency checking mechanism is implemented to identify pending writes that are to be released prior to releasing a PIM memory request. For example, a memory controller 114 is implemented that includes dependency checking logic to compare memory addresses associated with memory requests of PIM processor 112 with memory addresses associated with other memory requests (e.g., write requests that are dependent on the memory requests of the PIM processor 112) to resolve any hardware dependencies before releasing the memory requests of the PIM processor. In at least one variation, the dependency checking logic is hardware comparator logic that is used to identify any write requests that are dependent on a given memory request of the PIM processor 112. Broadly, a PIM address comparison is different from other address comparisons. This is because typically the PIM processor 112 operates on all-bank addresses. Therefore, PIM dependency checks involve comparing addresses to all banks of a memory.

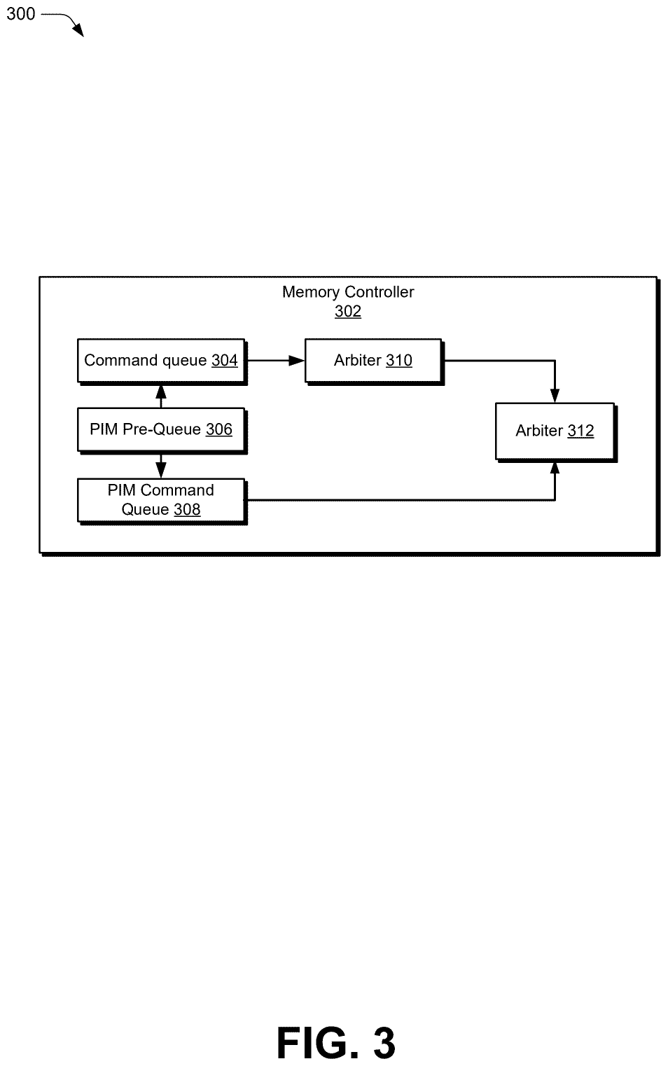

FIG. 3 is a block diagram of an example system 300 that includes a memory controller configured to implement a PIM scope release operation. In the illustrated example, the memory controller 302 includes a command queue 304 configured to buffer memory requests from host processing devices (e.g., cached data updated by any core 108 and propagated to the memory controller via a coherence directory 124). In accordance with the present disclosure, the memory controller 302 also includes a PIM pre-queue 306 configured to buffer memory requests for a PIM processor 112 that have dependencies in the command queue 304 which have not yet been released to the memory 110. The memory controller 302 also includes a PIM command queue 308, which buffers memory requests from the PIM processor 112 that are ready for scheduling to be written to the memory 110 (e.g., PIM memory requests that do not have any remaining dependencies in the command queue 304). By way of example, incoming PIM memory requests are first buffered in the PIM pre-queue 306 until all dependent memory writes in the command queue 304 are resolved (e.g., forwarded to the arbiter 310 to be scheduled for writing back to the memory 110). Once the dependent writes (e.g., memory writes associated with the same region of the memory 110 as the memory request of the PIM processor) are resolved for a given PIM memory request, the given PIM memory request is then moved to the PIM command queue 308 to be scheduled or forwarded to the memory 110 (e.g., via arbiter 312. To that end, the arbiters 310, 312 include any devices configured to resolve conflicts between memory requests in the command queue 304 and PIM command queue 308.

In additional or alternative examples, the system 300 is implemented with a single command queue that performs the functions of the command queue 304, PIM pre-queue 306, and PIM command queue 308. For example, a ready bit is incorporated in memory requests of a PIM processor 112 to indicate whether a given memory request of a PIM processor is ready to be scheduled by arbiters 310, 312. For instance, the ready bit is updated to enable scheduling a given PIM memory request after its dependencies (e.g., older memory writes issued from a core 108, etc.) have been resolved.

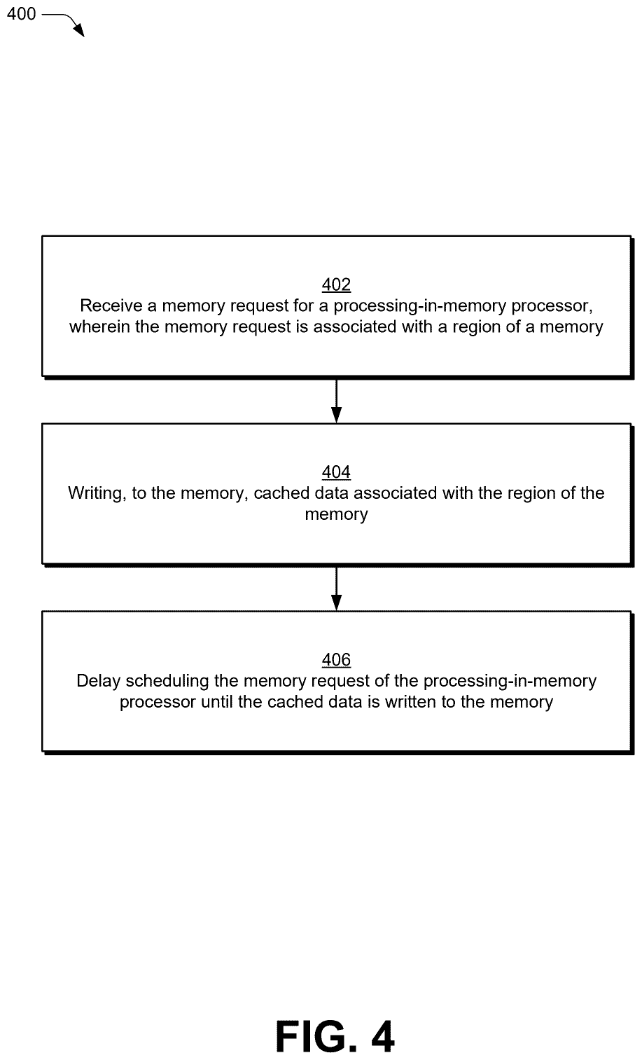

FIG. 4 depicts a procedure 400 in an example implementation of processing-in-memory scope release operations.

At block 402, a memory request is received for a PIM processor. The memory request is associated with a region of a memory (e.g., one or more memory addresses) associated with the PIM processor. For example, the memory controller 114(1) receives a memory request (e.g., memory read, memory write, etc.) from the host 102, where the memory request indicates that it is a memory request for the PIM processor 112(1). At block 404, the memory controller 114 writes, to the memory 110, cached data associated with the region of the memory. For example, cached data corresponding to the region of the memory that is to be accessed for the memory request of the PIM processor, which may be buffered in any of caches 118, 120, 122, coherence directory 124, and/or command queue 116, is flushed into the memory 110 prior to scheduling the memory request of the PIM processor 112. Thus, at block 406, the memory controller 114 delays scheduling the memory request of the processing-in-memory processor 112 until the cached data is written back to the memory 110.

The example techniques described herein are merely illustrative and many variations are possible based on this disclosure. Although features and elements are described above in particular combinations, each feature or element is usable alone without the other features and elements or in various combinations with or without other features and elements.

The various functional units illustrated in the figures and/or described herein (including, where appropriate, the host 102 having the core 108, the memory modules 104 having the memory 110 and the processing-in-memory processors 112, and the memory controllers 114) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a memory;
a processing-in-memory processor associated with the memory;
a memory controller, the memory controller configured to:
receive a memory request for the processing-in-memory processor, wherein the memory request is associated with a region of the memory;
schedule writing, into the memory, cached data associated with the region of the memory; and
delay scheduling the memory request of the processing-in-memory processor until the cached data is transmitted from the memory controller to the memory.

2. The system of claim 1, wherein the cached data corresponds to memory write requests from a host configured to access the memory via the memory controller.

3. The system of claim 1, wherein the memory controller is further configured to identify the region of the memory based on one or more memory requests including the memory request of the processing-in-memory processor.

4. The system of claim 1, further comprising:
a host; and
a command queue configured to buffer memory requests from the host, wherein the memory controller is configured to adjust an order of the memory requests such that one or more memory requests associated with the region of the memory are scheduled prior to the memory request of the processing-in-memory processor.

5. The system of claim 4, wherein the memory controller is further configured to update a ready bit of the memory request of the processing-in-memory processor in the command queue after the one or more memory requests associated with the region of the memory are transmitted from the memory controller to the memory, wherein updating the ready bit enables scheduling the memory request of the processing-in-memory processor.

6. The system of claim 1, further comprising a coherence directory configured to buffer the cached data, wherein the memory controller is further configured to obtain the cached data from the coherence directory in response to receiving the memory request for the processing-in-memory processor.

7. A method comprising:
receiving a memory request for a processing-in-memory processor, wherein the memory request is associated with a region of a memory;
writing, to the memory, cached data associated with the region of the memory; and
delay scheduling the memory request of the processing-in-memory processor until the cached data is written to the memory.

8. The method of claim 7, wherein the cached data corresponds to pending memory write operations requested by one or more processors configured to access the memory via a memory controller.

9. The method of claim 7, further comprising flushing the cached data from one or more caches in response to receiving the memory request for the processing-in-memory processor.

10. The method of claim 7, further comprising identifying the region of the memory based on one or more memory requests including the memory request of the processing-in-memory processor.

11. The method of claim 7, further comprising:
buffering, in a command queue of a memory controller, memory requests from one or more processors.

12. The method of claim 11, further comprising:
adjusting an order of the memory requests in the command queue such that one or more memory requests associated with the region of the memory are scheduled prior to the memory request of the processing-in-memory processor.

13. The method of claim 12, further comprising updating a ready bit of the memory request of the processing-in-memory processor in the command queue in response to transmission of the one or more memory requests associated with the region of the memory from the memory controller to the memory, wherein updating the ready bit enables scheduling the memory request of the processing-in-memory processor.

14. The method of claim 8, further comprising obtaining the cached data from a coherence directory associated with one or more processors in response to receiving the memory request for the processing-in-memory processor.

15. The method of claim 7, further comprising receiving one or more markers to release write requests to the memory; and
responsive to processing the one or more markers, writing, to the memory, the cached data associated with the region of the memory.

16. The method of claim 15, wherein the one or more markers to release write requests to the memory are processed to release the write requests from at least one of a coherence directory configured to buffer the cached data or an interface between the coherence directory and a memory controller.

17. The method of claim 7, further comprising buffering the memory request for the processing-in-memory processor in a separate queue from a processing-in-memory command queue until any write requests dependent on the memory request for the processing-in-memory processor are processed, wherein the write requests dependent on the memory request are identified using hardware comparator logic of a memory controller configured to perform a processing-in-memory address comparison with addresses of the write requests.

18. A device comprising:
a processing-in-memory processor associated with a memory;
a memory controller, the memory controller configured to:
receive a memory request for the processing-in-memory processor, wherein the memory request is associated with a region of the memory;
schedule writing, into the memory, cached data associated with the region of the memory; and
delay scheduling the memory request of the processing-in-memory processor until the cached data is transmitted from the memory controller to the memory.

19. The device of claim 18, further comprising:
a command queue configured to buffer memory requests from one or more processing devices.

20. The device of claim 19, wherein the memory controller is configured to:
adjust an order of the memory requests such that one or more memory requests associated with the region of the memory are scheduled prior to the memory request of the processing-in-memory processor; and
update a ready bit of the memory request of the processing-in-memory processor in the command queue after the one or more memory requests associated with the region of the memory are transmitted from the memory controller to the memory, wherein updating the ready bit enables scheduling the memory request of the processing-in-memory processor.
